(19) United States
(12) Patent Application Publication
(10) Pub. No.: US 2007/0092798 A1
(43) Pub. Date: Apr. 26, 2007

(54) LITHIUM ION BATTERIES

(76) Inventor: Timothy M. Spitler, Fernley, NV (US)

Correspondence Address: SHEPPARD MULLIN RICHTER & HAMPTON LLP, 48th Floor, 333 South Hope Street, Los Angeles, CA, 90071, US

(21) Appl. No.: 11/552,041

(22) Filed: Oct. 23, 2006

Related U.S. Application Data
(60) Provisional application No. 60/729,100, filed on Oct. 21, 2005.
(60) Provisional application No. 60/748,124, filed on Dec. 6, 2005.

(51) Int. Cl. H01M 4/48; H01M 4/50

(52) U.S. Cl. 429/224; 429/231.1

(57) ABSTRACT

The present invention is generally directed to lithium ion batteries. More specifically, it is directed to lithium ion batteries that provide for rapid recharge, longer battery life and inherently safe operation. In a battery aspect, the present invention provides a battery that includes the following elements: an anode comprising nano-crystalline Li₄Ti₅O₁₂ having a BET surface area of at least 10 m²/g; a cathode comprising nano-crystalline LiMn₂O₄ spinel having a BET surface area of at least 5 m²/g. The battery has a charge rate of at least 10 C.

### CROSS-REFERENCE TO RELATED APPLICATION

This application claims priority to U.S. Provisional Patent Application Ser. Nos. 60/729,100 filed on Oct. 21, 2005 and 60/748,124 filed on Dec. 6, 2005, the entire disclosures of which are incorporated by reference.

### FIELD OF THE INVENTION

The present invention is generally directed to lithium ion batteries. More specifically, it is directed to lithium ion batteries that provide for rapid recharge, longer battery life and inherently safe operation.

### BACKGROUND OF THE INVENTION

Improved lithium ion batteries have been the subject of research for many years. Examples of recent reports related to such research include: U.S. Pat. No. 7,115,339; U.S. Pat. No. 7,101,642; U.S. Pat. No. 7,087,349; U.S. Pat. No. 7,060,390; and, U.S. Pat. No. 7,026,074.

U.S. Pat. No. 7,115,339 discusses a lithium ion secondary battery including a positive electrode, a negative electrode, a separator interposed between the positive and negative electrodes, and an electrolyte prepared by dissolving a lithium salt in a non-aqueous solvent. The separator has a porous film layer containing basic solid particles and a composite binder. The porous film layer is adhered to at least one surface of at least one of the positive and negative electrodes. The composite binder includes a primary binder and a secondary binder, where the primary binder comprises polyether sulfone and the secondary binder comprises polyvinylpyrrolidone.

U.S. Pat. No. 7,101,642 reports a lithium ion battery that is configured to be able to discharge at very low voltage without causing permanent damage to the battery. One such battery discussed in the patent has a first active material including LiNiₓCo_{1-x-y}MyO₂, where M is Mn, Al, Mg, B, Ti or Li. It further has a second active material that contains carbon. The battery electrolyte reacts with the negative electrode of the battery to form a solid electrolyte interface layer.

U.S. Pat. No. 7,087,349 is directed to a lithium battery containing an organic electrolytic solution. The electrolytic solution includes a polymer adsorbent having an ethylene oxide chain capable of being adsorbed into a lithium metal. It further has a material capable of reacting with lithium to form a lithium alloy, a lithium salt, and an organic solvent. According to the patent, the organic electrolytic solution stabilizes the lithium metal and increases the lithium ionic conductivity.

U.S. Pat. No. 7,060,390 discusses a lithium ion battery containing a cathode that has a plurality of nanoparticles of lithium doped transition metal alloy oxides. The alloy oxides are represented by the formula LiₓCo_{y}NizO₂. The battery anode includes at least one carbon nanotube array, an electrolyte and a membrane separating the anode from the cathode. Carbon nanotube arrays within the anode have a plurality of multi-walled carbon nanotubes.

U.S. Pat. No. 7,026,074 reports a lithium battery having an improved safety profile. The battery utilizes one or more additives in the battery electrolyte solution, in which a lithium salt is dissolved in an organic solvent. Examples of additives include a blend of 2 weight percent triphenyl phosphate, 1 weight percent diphenyl monobutyl phosphate and 2 weight percent vinyl ethylene carbonate additives. The lithium salt is typically LiPF₆, and the electrolyte solvent is usually EC/DEC.

Despite the research performed on lithium ion batteries, there is still a need for lithium ion batteries exhibiting enhance profiles related to recharging, battery life and safety. Providing a lithium ion battery with such enhanced profiles is an object of the present invention.

### SUMMARY OF THE INVENTION

The present invention is generally directed to lithium ion batteries. More specifically, it is directed to lithium ion batteries that provide for rapid recharge, longer battery life and inherently safe operation.

In a battery aspect, the present invention provides a battery that includes the following elements: an anode comprising nano-crystalline Li₄Ti₅O₁₂ having a BET surface area of at least 10 m²/g; a cathode comprising nano-crystalline LiMn₂O₄ spinel having a BET surface area of at least 5 m²/g. The battery has a charge rate of at least 10 C.

### BRIEF DESCRIPTION OF THE DRAWINGS

FIG. 1 shows Li₄Ti₅O₁₂ spinel nano-crystalline particles.

FIG. 2 shows a graph of a plot of discharge capacity versus cycle number for a lithium ion cell constructed with nano-structured Li₄Ti₅O₁₂ anode materials.

FIG. 3 shows a graph of discharge capacity versus discharge rate and a graph of discharge capacity versus charge rate for a lithium ion cell constructed with nano-structured Li₄Ti₅O₁₂ anode materials as compared to a conventional lithium ion battery.

### DETAILED DESCRIPTION OF THE INVENTION

The batteries of the present invention comprise nano-materials, particularly in the context of the battery electrodes. The subject batteries provide practical charge rates that enable certain market segment products such as fast recharging batteries (e.g., a few minutes), batteries for electric vehicles and hybrid electric vehicles, and batteries for power tools. Nano-materials used in the present invention exhibit particular chemical properties that provide for greater safety and longer life; this results in significantly greater value over current technologies.

A decrease in electrode crystallite size decreases the diffusion distances that lithium ions have to move in the particles during electrochemical charge and discharge processes. The decrease in crystallite size, however, also increases the crystallite/electrolyte interface area available for the Li ions for intercalation into the crystallites according to the equation:
A=2π/ρR
where A is interface specific area, ρ is density and R is crystallite radius. The combination of both of these factors significantly improves the mass transport properties of the lithium ions inside of the active material particles and dramatically enhances the electrode's respective charge/discharge rate capability.

Moreover, the increase in electrode/electrolyte interface area, owing to the decrease in crystallite size, decreases the electrode interface impedance. The improvement in Li ion transport in the crystallites, also owing to the decrease in material particle size, decreases the diffusion controlled part of the electrode impedance. As a result, the decrease in crystallite size from several microns to tens of nanometers improves cell power performance dramatically.

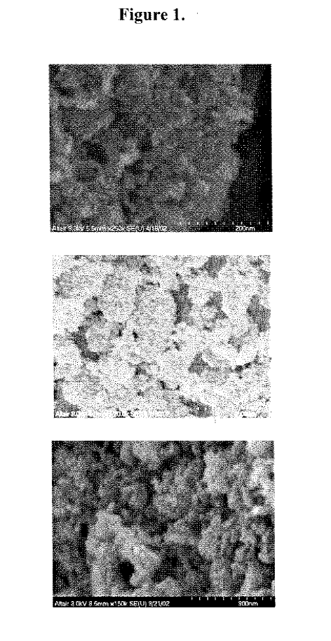

The improvement in rate capability and power performance provide materials allowing for high power and high rate battery applications. The present invention is directed to batteries having anodes comprising nano-crystalline Li₄Ti₅O₁₂ compounds. Such compounds are synthesized in a way that controls crystallite size, particle size particle shape, particle porosity and the degree of crystallite interlinking. Examples of Li₄Ti₅O₁₂ spinel nano-crystalline spherical particles are shown in FIG. 1.

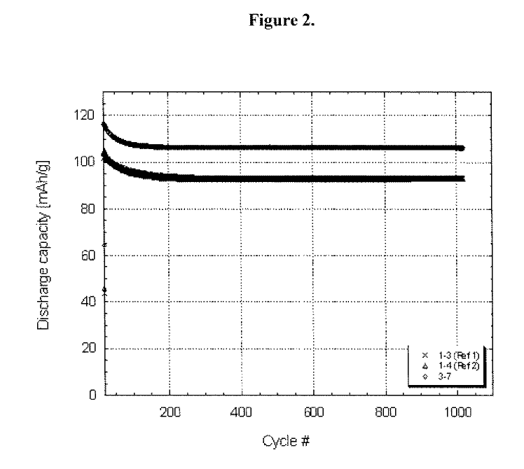

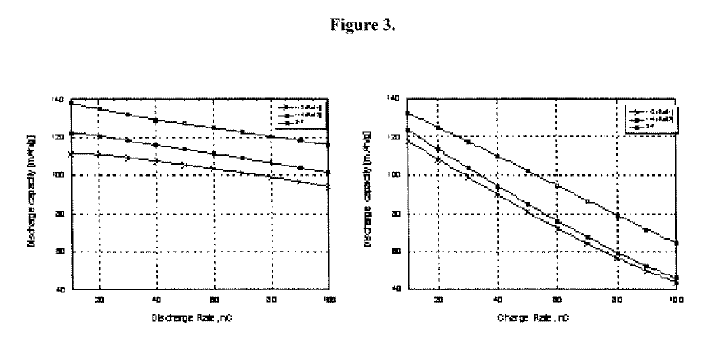

The Li₄Ti₅O₁₂ anode material comprises aggregates of nano-crystallites with well-defined porosity and crystallite interlinking. This results in optimal lithium ion transport into and out-of the particle's structure, as well as optimal electron transport between the crystallites. An example of discharge rate capability of lithium ion cells using this nano-crystalline material for a negative electrode is shown in FIG. 2. Cycling characteristics of the cells are shown in FIG. 3.

The nano-crystalline Li₄Ti₅O₁₂ material has a Brunauer-Emmet-Teller (BET) surface area of at least 10 m²/g. Typically, the material has a BET surface area ranging from 10 to 200 m²/g. Oftentimes, the material has a BET surface area ranging from 20 to 160 m²/g or 30 to 140 m²/g. In certain cases, the material has a BET surface area ranging from 70 to 110 m²/g.

Work related to the subject invention revealed that the impedance measured in commercially available batteries employing LiCoO₂ and LiNiXCo_{1-X}O₂ is controlled by the interface resistance of the positive electrode. Accordingly, changing the anode from carbon to Li₄Ti₅O₁₂ spinel—and taking into account the resultant voltage penalty—will cause a decrease in power capability when these commonly used materials are employed in the corresponding cathode. It was further found that using LiMn₂O₄ spinet as the cathode in combination with a Li₄Ti₅O₁₂ anode allows for superior battery performance due to the lower interface impedance and three dimensional structure of the manganite spinet material. Use of nano-structured LiMn₂O₄ additionally improves battery performance. Results of particular tests directed to nano-crystalline LiMn₂O₄ are shown in FIG. 3.

The nano-crystalline LiMn₂O₄ material generally has a BET surface area of at least 5 m²/g. Typically, the material has a BET surface area of at least 7.5 m²/g. Oftentimes, the material has a BET surface area of at least 10 m²/g or 15 m²/g. In certain cases, the material has a BET surface area of at least 20 m²/g or 25 m²/g.

Electrolyte solutions used in batteries of the present invention typically include an electrolyte, such as a lithium salt, and a non-aqueous solvent. Nonlimiting examples of such lithium salts include: fluorine-containing inorganic lithium salts (e.g., LiPF₆, LiBF₄); chlorine-containing inorganic lithium salts (e.g., LiClO₄); fluorine-containing organic lithium salts (e.g., LiN(CF₃SO₂)₂, LiN(C₂F₅SO₂)₂, LiCF₃SO₃, LiC(CF₃SO₂)₃, LiPF₄(CF₃)₂, LiPF₄(C₂F₅)₂, LiPF₄(CF₄SO₂)₂, LiPF₄(C₂F₅SO₂)₂, LiBF₂(CF₃)₂, LiBF₂(C₂F₅)₂, LiBF₂(CF₃SO₂)₂ and LiBF₂(C₂F₅SO₂)₂). Nonlimiting examples of the main component of nonaqueous solvents include a cyclic carbonate (e.g., ethylene carbonate and propylene carbonate), a linear carbonate (e.g., dimethyl carbonate and ethylmethyl carbonate, and a cyclic carboxylic acid ester (e.g., γ-butyrolactone and γ-valerolactone), or mixtures thereof.

The nonaqueous electrolytic solution may optionally contain other components. Such optional components include, without limitation, a conventionally known assistant, such as an overcharge preventing agent, a dehydrating agent and an acid remover. Nonlimiting examples of overcharge preventing agents include, an aromatic compound, such as biphenyl (e.g., an alkylbiphenyl, terphenyl, a partially hydrogenated product of terphenyl, cyclohexylbenzene, t-butylbenzene, t-amylbenzene, diphenyl ether and dibenzofuran); a partially fluorinated product of an aromatic compound (e.g., 2-fluorobiphenyl, o-cyclohexylfluorobenzene and p-cyclohexylfluorobenzene); and, a fluorine-containing anisole compound (e.g., 2,4-difluoroanisole, 2,5-difluoroanisole and 2,6-difluoroanisole).

Nonlimiting examples of an assistant for improving capacity maintenance characteristics and cycle characteristics after storing at a high temperature include: a carbonate compound (e.g., vinylethylene carbonate, fluoroethylene carbonate, trifluoropropylene carbonate, phenylethylene carbonate, ervthritan carbonate and spiro-bis-dimethylene carbonate); a carboxylic anhydride (e.g., succinic anhydride, glutaric anhydride, maleic anhydride, citraconic anhydride, glutaconic anhydride, itaconic anhydride, diglycolic anhydride, cyclohexanedicarboxylic anhydride, cyclopentanetetracarboxylic dianhydride and phenylsuccinic anhydride); a sulfur-containing compound (e.g., ethylene sulfite, 1,3-propanesultone, 1,4-butanesultone, methyl methanesulfonate, busulfan, sulfolane, sulfolene, dimethylsulfone, diphenylsulfone, methylphenylsulfone, dibutyldisulfide, dicyclohexyldisulfide, tetramethylthiuram monosulfide, N,N-dimethylmethanesulfoneamide and N,N-diethylmethanesulfoneamide); a nitrogen-containing compound (e.g., 1-methyl-2-pyrrolidinone, 1-methyl-2-piperidone, 3-methyl-2-oxazolidinone, 1,3-dimethyl-2-imidazolidinone and N-methylsuccinimide); a hydrocarbon compound (e.g., heptane, octane and cycloheptane); and, a fluorine-containing compound (e.g., fluorobenzene, difluorobenzene, hexafluorobenzene and benzotrifluoride). The compounds may be used individually or in combination.

Batteries of the present invention do not contain lead, nickel, cadmium, acids or caustics in the electrolyte solution.

The separator contained in the battery of the present invention may be of any suitable type. Nonlimiting examples of separators include: a polyolefin-based separator; a fluorinated polyolefin-based separator; a fluorine resin based separator (e.g., polyethylene separator); a polypropylene separator; a polyvinylidene fluoride separator, a VDF-HFP copolymer separator; a polyethylene/polypropylene bilayer separator; a polypropylene/polyethylene/polypropylene triple layer separator; and, a polyethylene/polypropylene/polyethylene triple layer separator.

Traditional lithium batteries have the following performance characteristics: charge rates of ½ C (i.e., 2 hours); discharge rates of 4 C (i.e., 15 minutes); cycle life of 300-500 cycles (shallow, not full depth of discharge “DOD”); and, a calendar life of 2-3 years. Batteries of the present invention typically have the performance characteristics as follows: charge rates of 10 C (i.e., 6 minutes), 20 C (i.e., 3 minutes) or higher; discharge rates of 10 C, 20 C, 30 C (i.e., 2 minutes), 40 C (i.e., 1.5 minutes) or higher; cycle life of 1,000, 2,000, 3,000 or higher (full DOD); and, a calendar life of 5-9 years or 10-15 years.

Traditional lithium power batteries exhibit potentially explosive thermal runaway problems above 130° C. The problem is exacerbated by high thermal impedances normally present at the electrode surfaces. The safety of the battery at practical charge and discharge rates is accordingly limited by heating caused by passing current through the high resistance. Under discharge and reverse discharge, expensive and sophisticated electronic circuitry is required to keep cells in charge and voltage balanced and to avoid dangerous states of overcharge.

Batteries of the present invention eliminate thermal runaway below 250° C. This is partially due to the very low internal impedance of electrode structures employing the included nano-structured materials, which allows for minimal heating during both charge and discharge at high currents. In addition, batteries of the present invention do not need the high level of expensive control circuitry necessary for standard lithium ion systems. This is because they can be safely overcharged, and the batteries are not damaged when fully discharged. The need for cell voltage balancing can be minimized from the control circuitry, which greatly reduces associated cost.

There are many uses for batteries of the present invention. Nonlimiting uses for the batteries include: a replacement for an uninterruptible power supply (UPS); battery for electric vehicles and hybrid electric vehicles; and, as a battery for power tools.

UPS systems use lead acid batteries or mechanical flywheels to provide backup power. Battery-based systems suffer from the tendency of lead acid batteries to fail and their need to be replaced every 1½ to 4 years. Furthermore, mechanical flywheels only provide 15-20 seconds of backup power; it is assumed that a generator will start in 8 seconds to provide further backup.

Batteries of the present invention are a solid a solid state replacement for flywheel UPS systems and requires no regular maintenance. The batteries will last up to 15 years in normal use and are designed to operate over a wide temperature range (−40° C. to +65° C.).

Traditional HEV battery systems suffer due to the use of heavy and/or toxic lead-acid cadmium, or nickel-based batteries. At a minimum, these batteries must be replaced every 5 to 7 years at a cost of several thousand dollars. Performance-wise, the limited power capabilities of current batteries limits the acceleration one can achieve from one battery power alone. This problem is exacerbated by the relative heavy weight of current HEV battery systems.

In addition to their environmental and weight advantages, batteries of the current invention possess exceedingly high discharge rates (up to 100 C and more) and charge rates of up to 40 C (currently unavailable using other technology). The high charge rate allows for a complete charge in about 1.5 minutes. Accordingly, not only do hybrid vehicles benefit from these breakthrough material advancements, but for the first time practical fully electric vehicles become a real option.

Battery packs are typically limited in size due to the weight of currently available power tool batteries. The size of the pack correspondingly limits the operating time per battery, and the recharge time for a battery pack can run from one to two hours. Moreover, most power tool battery systems include cadmium and nickel in addition to a caustic electrolyte.

In contrast, battery packs of the present invention typically weigh from one to two pounds and can be carried on a suspender belt. The pack is optimized for five to six hours of operation and can be recharged in 10 to 15 minutes. It also does not contain any nickel, cadmium or other harmful materials.

The following are nonlimiting examples of batteries of the present invention and their application:

1. A battery, where the battery comprises the following elements: an anode comprising nano-crystalline Li₄Ti₅O₁₂ having a BET surface area of at least 10 m²/g; a cathode comprising nano-crystalline LiMn₂O₄ spinel having a BET surface area of at least 5 m²/g; the battery has a charge rate of at least 10 C.

2. A battery, where the battery comprises the following elements: an anode comprising nano-crystalline Li₄Ti₅O₁₂ having a BET surface area of at least 10 m²/g; a cathode comprising nano-crystalline LiMn₂O₄ spinel having a BET surface area of at least 5 m²/g; the battery has a charge rate of at least 10 C; the battery has a discharge rate of at least 10 C.

3. A battery, where the battery comprises the following elements; an anode comprising nano-crystalline Li₄Ti₅O₁₂ having a BET surface area of at least 10 m²/g; a cathode comprising nano-crystalline LiMn₂O₄ spinel having a BET surface area of at least 5 m²/g; the battery has a charge rate of at least 10 C; the battery has a cycle life of at least 1,000 cycles.

4. A battery, where the battery comprises the following elements: an anode comprising nano-crystalline Li₄Ti₅O₁₂ having a BET surface area of at least 10 m²/g; a cathode comprising nano-crystalline LiMn₂O₄ spinel having a BET surface area of at least 5 m²/g; the battery has a charge rate of at least 10 C; the battery has a calendar life of 5-9 years.

5. A battery, where the battery comprises the following elements: an anode comprising nano-crystalline Li₄Ti₅O₁₂ having a BET surface area of at least 10 m²/g; a cathode comprising nano-crystalline LiMn₂O₄ spinel having a BET surface area of at least 5 m²/g; the battery has a charge rate of at least 10 C; the battery has a calendar life of 10-15 years.

6. A battery, where the battery comprises the following elements: an anode comprising nano-crystalline Li₄Ti₅O₁₂ having a BET surface area of at least 10 m²/g; a cathode comprising nano-crystalline LiMn₂O₄ spinel having a BET surface area of at least 5 m²/g; the battery has a charge rate of at least 10 C; the battery does not contain lead, nickel, cadmium, acids or caustics in the electrolyte solution.

7. A battery, where the battery comprises the following elements, an anode comprising nano-crystalline Li₄Ti₅O₁₂ having a BET surface area of at least 10 m²/g; a cathode comprising nano-crystalline LiMn₂O₄ spinel having a BET surface area of at least 5 m²/g; the battery has a charge rate of at least 10 C; the battery eliminates thermal runaway below 250° C.

8. A battery, where the battery comprises the following elements: an anode comprising nano-crystalline Li₄Ti₅O₁₂ having a BET surface area ranging from 30 to 140 m²/g; a cathode comprising nano-crystalline LiMn₂O₄ spinet having a BET surface area of at least 5 m²/g; the battery has a charge rate of at least 10 C.

9. A battery, where the battery comprises the following elements: an anode comprising nano-crystalline Li₄Ti₅O₁₂ having a BET surface area ranging from 30 to 140 m²/g; a cathode comprising nano-crystalline LiMn₂O₄ spinel having a BET surface area of at least 5 m²/g; the battery has a charge rate of at least 10 C; the battery has a discharge rate of at least 10 C.

10. A battery, where the battery comprises the following elements: an anode comprising nano-crystalline Li₄Ti₅O₁₂ having a BET surface area ranging from 30 to 140 m²/g; a cathode comprising nano-crystalline LiMn₂O₄ spinet having a BET surface area of at least 5 m²/g; the battery has a charge rate of at least 10 C; the battery has a cycle life of at least 1,000 cycles.

11. A battery, where the battery comprises the following elements: an anode comprising nano-crystalline Li₄Ti₅O₁₂ having a BET surface area ranging from 30 to 140 m²/g; a cathode comprising nano-crystalline LiMn₂O₄ spinel having a BET surface area of at least 5 m²/g; the battery has a charge rate of at least 10 C; the battery has a calendar life of 5-9 years.

12. A battery, where the battery comprises the following elements: an anode comprising nano-crystalline Li₄Ti₅O₁₂ having a BET surface area ranging from 30 to 140 m²/g; a cathode comprising nano-crystalline LiMn₂O₄ spinel having a BET surface area of at least 5 m²/g; the battery has a charge rate of at least 10 C; the battery has a calendar life of 10-15 years.

13. A battery, where the battery comprises the following elements: an anode comprising nano-crystalline Li₄Ti₅O₁₂ having a BET surface area ranging from 30 to 140 m²/g; a cathode comprising nano-crystalline LiMn₂O₄ spinel having a BET surface area of at least 5 m²/g; the battery has a charge rate of at least 10 C; the battery does not contain lead, nickel, cadmium, acids or caustics in the electrolyte solution.

14. A battery, where the battery comprises the following elements: an anode comprising nano-crystalline Li₄Ti₅O₁₂ having a BET surface area ranging from 30 to 140 m²/g; a cathode comprising nano-crystalline LiMn₂O₄ spinel having a BET surface area of at least 5 m²/g; the battery has a charge rate of at least 10 C; the battery eliminates thermal runaway below 250° C.

15. A battery, where the battery comprises the following elements: an anode comprising nano-crystalline Li₄Ti₅O₁₂ having a BET surface area ranging from 30 to 140 m²/g; a cathode comprising nano-crystalline LiMn₂O₄ spinet having a BET surface area of at least 10 m²/g; the battery has a charge rate of at least 20 C; the battery has a discharge rate of at least 20 C.

16. A battery, where the battery comprises the following elements: an anode comprising nano-crystalline Li₄Ti₅O₁₂ having a BET surface area ranging from 30 to 140 m²/g; a cathode comprising nano-crystalline LiMn₂O₄ spinel having a BET surface area of at least 10 m²/g; the battery has a charge rate of at least 20 C; the battery has a discharge rate of at least 20 C; the battery has a cycle life of at least 1,000 cycles.

17. A battery, where the battery comprises the following elements: an anode comprising nano-crystalline Li₄Ti₅O₁₂ having a BET surface area ranging from 30 to 140 m²/g; a cathode comprising nano-crystalline LiMn₂O₄ spinel having a BET surface area of at least 10 m²/g; the battery has a charge rate of at least 20 C; the battery has a discharge rate of at least 20 C; the battery has a cycle life of at least 1,000 cycles; the battery has a calendar life of 10-15 years.

18. A battery, where the battery comprises the following elements: an anode comprising nano-crystalline Li₄Ti₅O₁₂ having a BET surface area ranging from 30 to 140 m²/g; a cathode comprising nano-crystalline LiMn₂O₄ spinel having a BET surface area of at least 10 m²/g; the battery has a charge rate of at least 20 C; the battery has a discharge rate of at least 20 C; the battery has a cycle life of at least 1,000 cycles; the battery has a calendar life of 10-15 years; the battery does not contain lead, nickel, cadmium, acids or caustics in the electrolyte solution.

19. A battery, where the battery comprises the following elements: an anode comprising nano-crystalline Li₄Ti₅O₁₂ having a BET surface area ranging from 30 to 140 m²/g; a cathode comprising nano-crystalline LiMn₂O₄ spinel having a BET surface area of at least 10 m²/g; the battery has a charge rate of at least 20 C; the battery has a discharge rate of at least 20 C; the battery has a cycle life of at least 1,000 cycles; the battery has a calendar life of 10-15 years; the battery does not contain lead, nickel, cadmium, acids or caustics in the electrolyte solution; the battery eliminates thermal runaway below 250° C.

20. A battery, where the battery comprises the following elements: an anode comprising nano-crystalline Li₄Ti₅O₁₂ having a BET surface area ranging from 30 to 140 m²/g; a cathode comprising nano-crystalline LiMn₂O₄ spinet having a BET surface area of at least 10 m²/g; the battery has a charge rate of at least 20 C; the battery has a discharge rate of at least 20 C; the battery has a cycle life of at least 2,000 cycles; the battery has a calendar life of 10-15 years; the battery does not contain lead, nickel, cadmium, acids or caustics in the electrolyte solution; the battery eliminates thermal runaway below 250° C.

21. A battery, where the battery comprises the following elements: an anode comprising nano-crystalline Li₄Ti₅O₁₂ having a BET surface area ranging from 30 to 140 m²/g; a cathode comprising nano-crystalline LiMn₂O₄ spinet having a BET surface area of at least 10 m²/g; the battery has a charge rate of at least 20 C; the battery has a discharge rate of at least 20 C; the battery has a cycle life of at least 3,000 cycles; the battery has a calendar life of 10-15 years; the battery does not contain lead, nickel, cadmium, acids or caustics in the electrolyte solution; the battery eliminates thermal runaway below 250° C.

22. A battery, where the battery comprises the following elements: an anode comprising nano-crystalline Li₄Ti₅O₁₂ having a BET surface area ranging from 30 to 140 m²/g; a cathode comprising nano-crystalline LiMn₂O₄ spinel having a BET surface area of at least 10 m²/g; the battery has a charge rate of at least 20 C; the battery has a discharge rate of at least 40 C; the battery has a cycle life of at least 3,000 cycles; the battery has a calendar life of 10-15 years; the battery does not contain lead, nickel, cadmium, acids or caustics in the electrolyte solution; the battery eliminates thermal runaway below 250° C.

23. A replacement for an uninterruptible power supply, where the replacement is a battery of sections 1-22 above.

24. An electric vehicle, where the electric vehicle comprises a battery of sections 1-22 above.

25. A hybrid electric vehicle, where the hybrid electric vehicle comprises a battery of sections 1-22 above.

26. A power tool, where the tool comprises a battery of sections 1-22 above.

1. A battery, wherein the battery comprises:
a) an anode comprising nano-crystalline Li₄Ti₅O₁₂ having a BET surface area of at least 10 m²/g;
b) a cathode comprising nano-crystalline LiMn₂O₄ spinel having a BET surface area of at least 5 m²/g;
wherein the battery has a charge rate of at least 10 C.

2. The battery according to claim 1, wherein the battery has a discharge rate of at least 10 C.

3. The battery according to claim 2, wherein the battery has a cycle life of at least 1,000 cycles.

4. The battery according to claim 3, wherein the battery has a calendar life of 5-9 years.

5. The battery according to claim 3, wherein the battery has a calendar life of 10-15 years.

6. The battery according to claim 5, wherein the battery does not contain lead, nickel, cadmium, acids or caustics in the electrolyte solution.

7. The battery according to claim 6, wherein the battery eliminates thermal runaway below 250° C.

8. The battery according to claim 7, wherein the nano-crystalline Li₄Ti₅O₁₂ has a BET surface area ranging from 30 to 140 m²/g

9. The battery according to claim 8, wherein the nano-crystalline LiMn₂O₄ spinel has a BET surface area of at least 10 m²/g.

10. The battery according to claim 9, wherein the battery has a cycle life of at least 2,000 cycles.

11. A replacement for an uninterruptible power supply, wherein the replacement is a battery according to claim 5.

12. An electric vehicle, wherein the electric vehicle comprises a battery according to claim 5.

13. A hybrid electric vehicle, wherein the hybrid electric vehicle comprises a battery according to claim 5.

14. A power tool, wherein the power tool comprises a battery according to claim 5.
